(19) United States
(12) Patent Application Publication
(10) Pub. No.: US 2026/0170446 A1
(43) Pub. Date: Jun. 18, 2026

(54) ARTIFICIAL INTELLIGENCE/MACHINE LEARNING DRIVEN ORGANIZATION RECOMMENDATION ENGINE SYSTEMS AND METHODS

(71) Applicant: AT&T Intellectual Property I, L.P., Atlanta, GA (US)

(72) Inventors: Vivek Rajasekharan, Plano, TX (US); Tzvi Chumash, Matawan, NJ (US); Mark Austin, Lucas, TX (US)

(73) Assignee: AT&T Intellectual Property I, L.P., Atlanta, GA (US)

(21) Appl. No.: 18/978,110

(22) Filed: Dec. 12, 2024

(51) Int. Cl. G06Q 10/0639

(52) U.S. Cl. CPC G06Q 10/06398

(57) ABSTRACT

Aspects of the subject disclosure may include, for example, collecting internal datasets such that the internal datasets represent a comprehensive map of activities by a plurality of operation teams in a target organization; generating, using a data aggregation agent, aggregated data of the internal datasets; based on an automatic trigger or a trigger by a user, performing an optimization process including: in a pool of artificial intelligence/machine learning (AI/ML) models, selecting, using an AI/ML selection agent, a set of AI/ML models to identify similarities in the characteristics of the plurality of operation teams; and using the aggregated data, analyzing performance metrics of the plurality of operation teams; and based on the identified similarities and the analyzed performance metrics, generating an output including optimization actions of the plurality of operation teams. Other embodiments are disclosed.

### FIELD OF THE DISCLOSURE

The subject disclosure relates to artificial intelligence/machine learning (AI/ML) driven organization recommendation engine systems and methods.

### BACKGROUND

Organizations may encounter challenges due to diverse units with overlapping functions and similar capabilities. This overlap may lead to inefficiencies and redundancies, hindering optimal performance and resource utilization.

Traditional methods often involve across-the-board cuts, which may harm organizational divisions and reduce overall capacity. These methods may fail to pinpoint specific areas where redundancies exist and where consolidation could enhance efficiency without compromising capabilities.

Additionally, the lack of a comprehensive view of organizational activities may prevent the identification of synergies and collaboration opportunities. Manual project documentation and feature creation are time-consuming and prone to errors, leading to inconsistencies and inefficiencies in project management and reporting.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a data source in accordance with various aspects described herein.

FIG. 2B is a block diagram illustrating an example, non-limiting embodiment of a system functioning within the communication network of FIG. 1 in accordance with various aspects described herein.

FIG. 2C through 2F depict illustrative examples of optimization actions in accordance with various aspects described herein.

FIG. 2G depicts illustrative examples of triggers and actions in accordance with various aspects described herein

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for artificial intelligence/machine learning (AI/ML) driven organization recommendation engine (ORE) systems and methods. The artificial intelligence/machine learning (AI/ML) driven (ORE) systems and methods leverage data and models to drive efficiency into the organizational structure. The ORE systems and methods collect and aggregate internal datasets representing a comprehensive map of organization activities including interactions, projects, and applications, and enabling a comprehensive understanding of how different parts of an organization interact and overlap. The ORE systems and methods utilize data and the AI/ML model-driven approaches that analyze the internal datasets and identify predetermined patterns or predetermined metrics which are indicative of optimization opportunity. The ORE systems and methods generate and output, using the AI/ML model, optimization recommendations or actions responsive to the optimization opportunity. Other embodiments are described in the subject disclosure.

One or more aspects of the subject disclosure are directed to a non-transitory machine-readable medium, comprising executable instructions that, when executed by a processing system including a processor, facilitate performance of operations. The operations include collecting, using a set of analytics tools, internal datasets such that the internal datasets represent a comprehensive map of activities by a plurality of operation teams in a target organization, wherein the internal datasets include different data sources and each data source corresponds to a plurality of key data points representing characteristics of the plurality of operation teams in the target organization; generating, using a data aggregation agent, aggregated data of the internal datasets; based on an automatic trigger or a trigger by a user, performing an optimization process including: in a pool of artificial intelligence/machine learning (AI/ML) models, selecting, using an AI/ML selection agent, a set of AI/ML models to identify similarities in the characteristics of the plurality of operation teams; using the aggregated data; and analyzing performance metrics of the plurality of operation teams; and based on the identified similarities and the analyzed performance metrics, generating an output including optimization actions of the plurality of operation teams.

One or more aspects of the subject disclosure are directed to a method including steps of collecting, by a processing system including a processor, internal datasets such that the internal datasets represent a comprehensive map of activities by a plurality of operation teams in a target organization, wherein the internal datasets contain different data sources and each data source includes a plurality of key data points representing characteristics of the plurality of operation teams in the target organization; generating, by the processing system, aggregated data of the internal datasets; triggering an optimization process including: in a pool of artificial intelligence/machine learning (AI/ML) models, selecting a set of AI/ML models trained to identify similarity within the plurality of operation teams; and analyzing performance metrics indicative of performance levels by the plurality of operation teams, wherein the performance metrics are included in the internal datasets; and based on the identified similarity and the analyzed performance metrics, generating an output including optimization actions directed to the plurality of operation teams in the target organization.

One or more aspects of the subject disclosure are directed to a system having a processing system including a processor and a memory that stores executable instructions that, when executed by the processing system, facilitate performance of operations. The operations include collecting internal datasets such that the internal datasets represent a comprehensive map of activities by a plurality of operation teams in a target organization, wherein the internal datasets contain different data sources and each data source includes a plurality of key data points representing characteristics of the plurality of operation teams in the target organization; generating, by the processing system, aggregated data based on the different data sources of the internal datasets; based on a trigger by the system or by a user, performing an optimization process including: in a pool of artificial intelligence/machine learning (AI/ML) models, selecting a set of AI/ML models trained to identify predetermined patterns across the plurality of operation teams; based on the aggregated data, and analyzing performance metrics of the plurality of operation teams; and using the identified predetermined patterns and the analyzed performance metrics, generating actions that optimize the plurality of operation teams in the target organization.

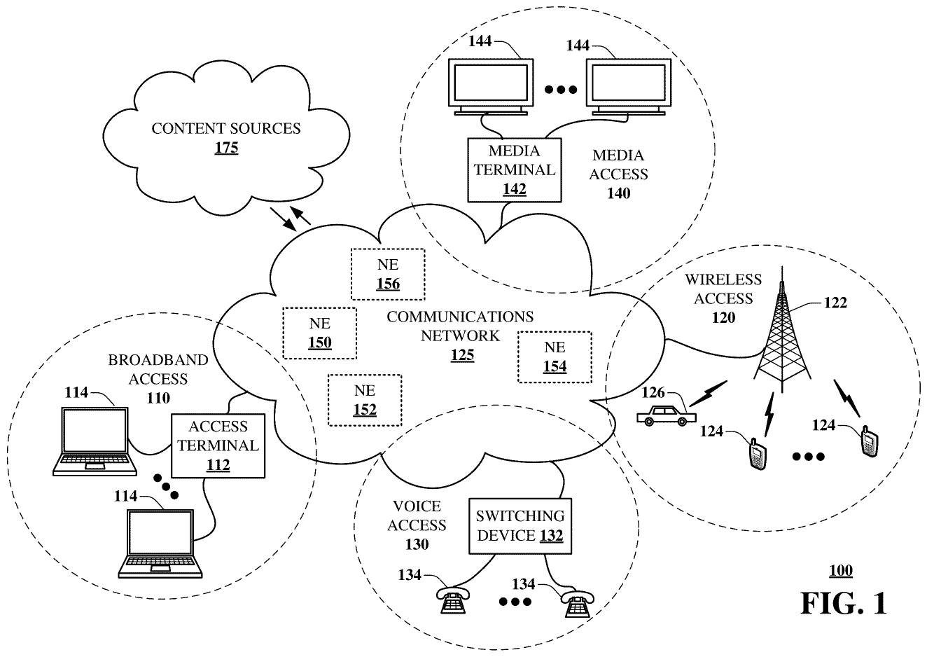

Referring now to FIG. 1, a block diagram is shown illustrating an example, non-limiting embodiment of a system 100 in accordance with various aspects described herein. For example, system 100 can facilitate in whole or in part AI/ML driven organization recommendation engine (ORE) systems and methods. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The subject disclosure describes, among other things, illustrative embodiments for organization recommendation engine (ORE) systems and methods. The ORE systems and methods ingest and process all available data, leveraging advanced artificial intelligence (AI) to perform comprehensive analyses and uncover patterns. These insights help determine existing team compositions, enhance project and application understanding, and generate detailed performance metrics for the teams. The ORE systems and methods trigger processes when specific conditions are met, sending alerts to appropriate downstream recipients to ensure timely and relevant actions.

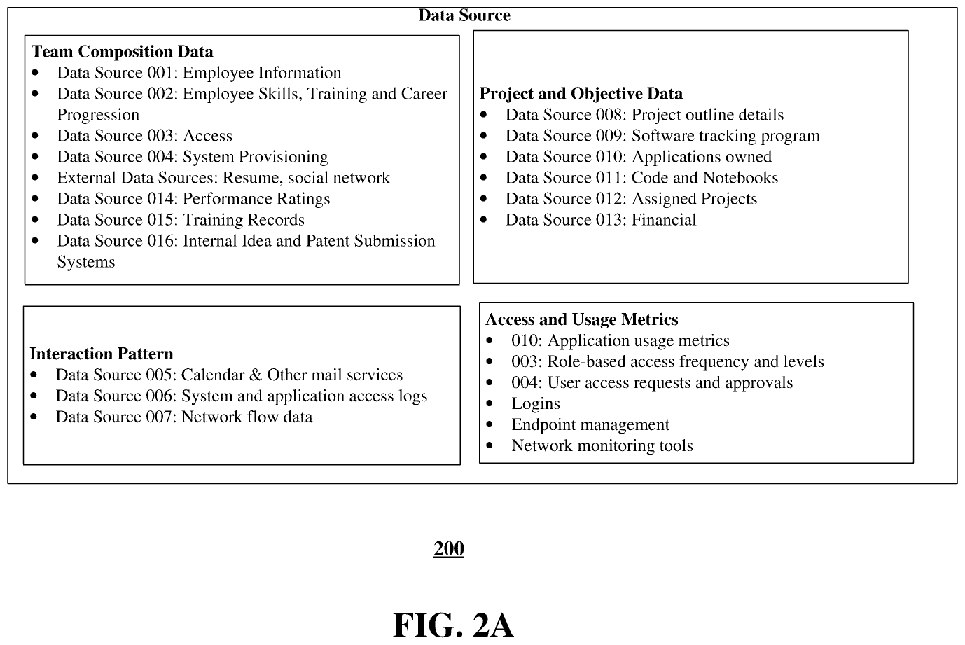

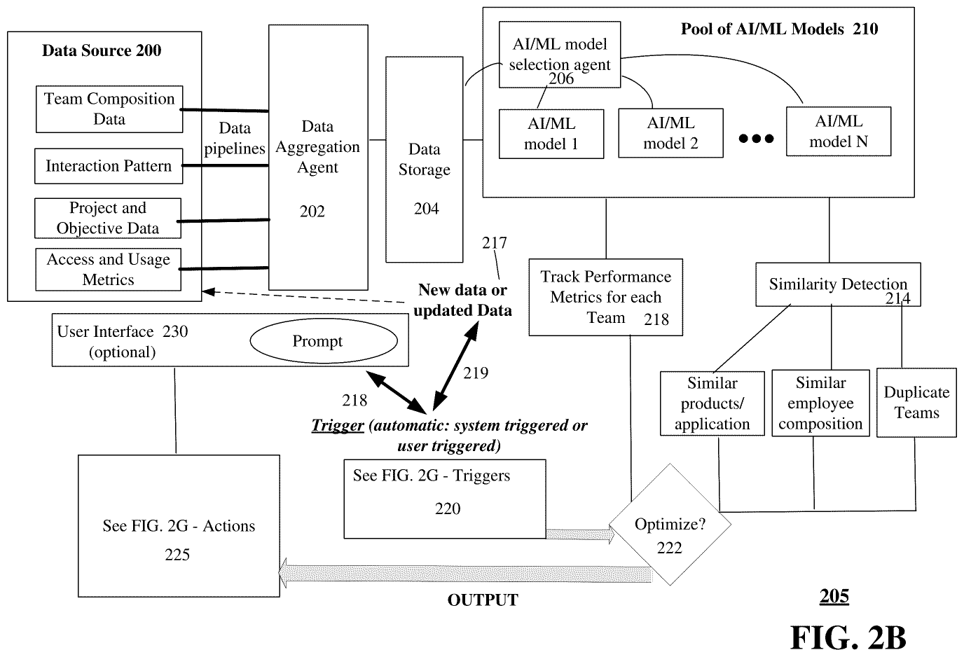

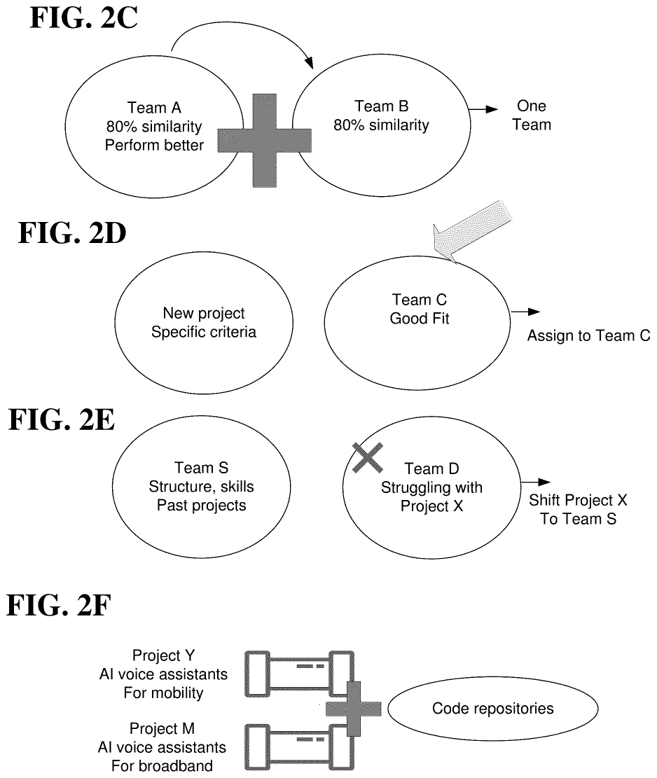

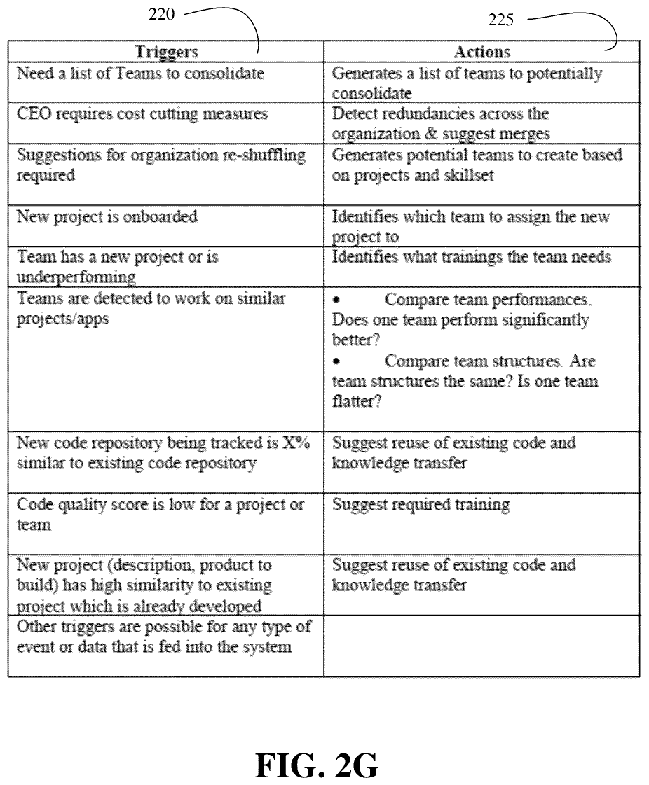

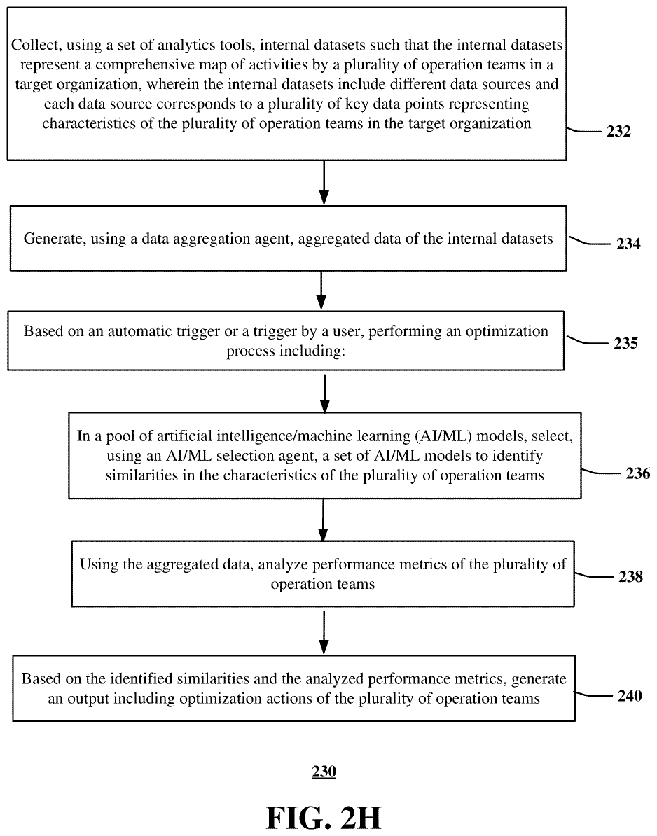

FIG. 2A is a block diagram illustrating an example, non-limiting embodiment of a data source 200 for use in ORE systems and methods in accordance with various aspects described herein. In various embodiments, the data source 200 includes Team composition data, Interaction pattern, Project and objective data, and Access and usage metrics by way of example. The data source 200 is not limited thereto and may include various different data groups. Based on the scope and functions of the ORE systems and methods, the data source 200 may be modified to add or remove certain data content in various use cases.

In various embodiments, different data groups contain specific datasets focusing key data points. In the fields of data science and artificial intelligence, key data points refer to specific pieces of information that are crucial for analysis, modeling, and decision-making processes. These data points are essential for understanding patterns, trends, and relationships within a dataset. They serve as the foundation for building predictive models, performing statistical analyses, and generating insights. Characteristics of Key Data Points include relevance, accuracy, completeness, consistency, granularity, etc. For instance, in customer analytics, key data points may include customer demographics (age, gender, location), purchase history, browsing behavior, and customer feedback. In financial analysis, key data points could include revenue, expenses, profit margins, stock prices, and financial ratios. In operations management, key data points might include production volumes, inventory levels, supply chain metrics, and equipment utilization rates. In healthcare analytics, key data points could include patient demographics, medical history, treatment outcomes, and lab test results. In IoT (Internet of Things) applications, key data points might include temperature readings, humidity levels, device status, and usage patterns. Behavioral Data: In user behavior analysis, key data points could include clickstream data, session duration, page views, and interaction patterns. Overall, key data points provide the necessary information to build accurate models, generate insights, and make informed decisions.

In various embodiments, the team composition data includes Data Source 001 through Data Source 004. Data Source 001 includes employee information which contains detailed information about employee organizational structure and titles. Key data points include employee names, departments, reporting hierarchy, job titles, etc. Data Source 002 includes employee skills, training and career progression. Data Source 200s tracks skillsets, training history, and career path progression. Key data points for Data Source 002 include skills acquired, training sessions completed, certifications, career milestones. Data Source 003 corresponds to Access which describes employee's Role-Based Access Control (RBAC) to applications. Key data points include permissions, roles, access levels, login times, etc. Data Source 004 includes system provisioning which manages user access to systems and applications. Key data points include access requests, approval workflows, access revocations. Additionally, external data sources can be used to provide data such as resumes, data input via social networks or social media. External data sources can provide additional context, especially useful for new hires. Key data points include previous work experience, educational background, professional endorsements.

In various embodiments, Interaction patterns include Data Source 005 through Data Source 007. By way of example, Data Source 005 includes calendar and other mail services which tracks meeting schedules and interactions. Key Data Points include meeting frequency, attendees, duration, topics discussed. Data Source 006 corresponds to system and application access Logs which include logs detailing how often employees access systems or applications. Key data points include access frequency, duration of use, specific actions taken within applications (e.g., frequency and duration of use of data management application or data visualization application). Data Source 007 corresponds to network flow data which tracks employee interactions with application servers. Key Data Points include data transfer volumes, connection times, server endpoints accessed.

In various embodiments, Project and objective Data include Data Source 008 through Data Source 013 as depicted in FIG. 2A. Data Source 008 includes project outline details, such as professional services vendor statement of work, etc. The project outline details compiles comprehensive details about projects, applications, objectives, timelines, and work items. Key data points include project names, objectives, timelines, milestones. Data Source 009 includes software tracking (i.e., Software Development Lifecycle) work Items and tickets which track work items and tickets through various project management tools. Key data points include tickets created and closed, work item details, timelines (e.g., collaboration applications, version control applications, etc.). Data Source 010 includes Applications owned which contains information about applications owned and managed by employees. Key data points include application names, ownership details, usage metrics. Data Source 011 includes code and notebooks which contain code Repositories and data science notebooks. Key data points include code repositories (e.g., GitHub), data notebooks (e.g., Databricks), version history.

Data Source 012 include assigned projects which contain employees charging time against projects/applications. Key data points include project names, roles assigned, progress metrics. Data Source 013 corresponds to Financial data which contain financial impact of the project if complete or proposed financial impact. Key data points include cost savings, revenue generated, etc.

In various embodiments, the data source 200 includes access and usage metrics relating to access logs, usage frequency, endpoint management metrics, network monitoring data with tools. For example, the access and usage metrics include 010: Application usage metrics, 003: Role-based access frequency and levels, 004: User access requests and approvals, Logins (e.g., Login frequency and duration), endpoint management such as device compliance and usage metrics, network monitoring Tools including data flow and network usage patterns, etc.

FIG. 2B is a block diagram illustrating an example, non-limiting embodiment of an organization recommendation engine (ORE) system 205 functioning within the communication network of FIG. 1 in accordance with various aspects described herein. The ORE system 205 leverages data and models to drive efficiency into the organizational structure. The ORE system 205 is configured to ingest and process all available data in the data source 200 as depicted in FIG. 2A, leveraging artificial intelligence/machine learning (AI/ML) models to perform comprehensive analyses and uncover patterns to determine existing team compositions, enhance project and application understanding, and generate detailed performance metrics for the teams. As depicted in FIG. 2B, the ORE system 205 then generates an output including recommendations or actions 225 which will trigger (220) processes when specific conditions are met, sending alerts to the appropriate downstream recipients to ensure timely and relevant actions. As depicted in FIG. 2B, tasks are triggered automatically or triggered by a user (218, 219, 220), data sources are continuously and seamlessly updated with new data (217), and an update could “trigger” agents to re-calculate data. Various examples of triggers 220 and actions 225 are illustrated in FIG. 2G and will be described below in connection with FIG. 2G.

Traditional methods can rely on across-the-board cuts that harm silos. Silos in an organizational context may refer to a system, process, department, or team that operates in isolation from others. This separation can lead to a lack of communication and collaboration, resulting in inefficiencies and redundancies within the organization. Silos can hinder the sharing of information and resources, making it difficult to achieve overall organizational goals and optimize performance. The ORE system 205 utilizes a data and model-driven approach that can identify silos that would be good candidates for mergers. Merging these silos can reduce redundancies without compromising capacity, resulting in a more cohesive and efficient organization.

In various embodiments, the ORE system 205 utilizes internal datasets and user behavior to detect teams that have some level of overlap as well as potential complimentary features. As depicted in FIG. 2B, the ORE system 205 aims to streamline operations by consolidating data from various sources (e.g., the data source 200 in FIG. 2A) to create a comprehensive view of organizational activities and utilizing advanced analytics, using the AI/ML models to detect patterns of overlap and redundancy. The ORE system 205 identifies overlap and consolidation opportunities in teams, applications, and projects and performs optimization (222) in response to various triggers 220, resulting in corresponding actions 225.

In various embodiments, the ORE system 205 includes the data source 200 and a pool of AI/ML models 210 coupled to a data storage 204 where the internal datasets in the data source 200 are stored and accessed by the pool of AI/ML model 210. Data pipelines are formed to provide the internal datasets in the data source 200 to the data storage 204 and the pool of AI/ML models 210.

As described in connection with FIG. 2A, the Team composition data gather information on team roles, level of expertise, skills, scope of knowledge, methods of operation and tasks (e.g., employee information (Employee names, departments, reporting hierarchy, job titles, career intelligence, project management and resource allocation applications, user access management for controlling and monitoring user access to various applications, logins, resumes, social media data). The information is classified and labeled as Data Sources 001 through 004 and external data sources is separately classified.

The interaction patterns collect data on interaction patterns and frequency (e.g., calendar data, system and application access logs, network flow data). Such information is classified and labeled as Data Source 005 through 007. Thus, the ORE system 205 identifies, based on the data source 200, redundant client meetings, comparable team capabilities, employee utilization levels, and reorganization opportunities based on roles.

The project and objective data compile details on projects, applications, objectives, timelines, and work items. The information is classified and labeled as Data Source 008 through 013. The ORE system 205, based on the project and objective data, assesses team similarity (similar apps/projects, similar employee capabilities, similar team structures (e.g., flat vs. pyramid)) and performance metrics (e.g., release frequency, agility), understand the team functions by comparing statement of work from all contracts related to the team's applications. The ORE system 205 also identifies redundant applications and projects, which subsequently help in detecting overlap among teams. In addition to identifying overlapping projects and applications, the ORE system 205 can also detect parallel feature development across different projects, related research projects, and similar code repositories.

With respect to the access and usage metrics, the ORE system 205 analyzes access and usage metrics (e.g., a team collaboration platform, project management and resource allocation applications, user access management for controlling and monitoring user access to various applications, logins, endpoint management, and network monitoring tools). Additionally or alternatively, the ORE system 205 tracks and analyzes, as access and usage metrics information, frequency of ticket closures, pull requests, resource utilization, code quality score, code size, predictive financial modeling, employee activity, past performance, self-development, ideas submitted, employee network, etc. Additionally, the ORE system 205 will show and ensure statistical significance or predictability of selected skills. The OR system 205 is configured to prove that the selected skills influence performance statistics that matter. This can be done through training of machine learning models.

As depicted in FIG. 2B, the data source 200 is connected with a data aggregation agent 202. The data pipelines provide data from the data source 200 to the data aggregation agent 202. The data aggregation agent 202 collects and aggregate various data in different formats and having different content from the data source 200. The data source 200 can be continuously and seamlessly updated. The data source 200 may include structured data or unstructured data. For instance, the data aggregation agent 202 aggregates image files, video files, documents, calendar files, metric files, web documents, etc. from the data source 200 and aggregates various data.

In various embodiments, the data aggregation agent 202 further aggregates metric data or information using various analytics tools for use in organizations. For instance, each team is using a project management tool to plan, track, release and support software and with the project management tool, tickets or a working product completion time can be tracked and a number of tickets closed can be determined. With respect to code, using a code repository, it is determined how many pull requests are being sent, a frequency of pull requests, time and resources spent on a project, a quality of code and updates made to the code, etc. Information relating to numeric, quantitative metrics such as the tickets closed as well as qualitative metrics such as the quality of code can be tracked to identify relevant metrics data.

The aggregated data by the data aggregation agent 202 include composition data from a particular organization and represent various and different aspects of the particular organization. As the data source 200 is updated with new data, the data aggregation agent 202 may be triggered to recalculate data aggregation parameters. The aggregated data are stored in the data storage 204.

In various embodiments, the ORE system 205 includes the pool of AI/ML models 210 which includes an AI/ML model 1, an AI/ML model 2, an AI/ML model N, etc. The pool of AI/ML model 210 also includes an AI/ML model selection agent 206 which accesses the data storage 204 and determines or select a suitable AI/ML model relevant to a particular data type among the pool of AI/ML model 210. For instance, the data source 204 include a vast amount of organization information in text files or document files. By way of example, the AI/ML model selection agent 206 selects a large language model (LLM) to search and retrieve information from the data storage 204 and perform natural language tasks such as question and answer, information retrieval, searching, analysis, etc.

The pool of AI/ML model 210 can be implemented using available AI/ML models such as graphs, clustering algorithms, Principal Component Analysis (PCA), Latent Dirichlet Allocation (LDA), Decision Trees, Random Forest, Neural Networks (Deep Learning, GNNs, RNNs), Bayesian Models, Community Detection Algorithms, Recommendation Systems, Large Language Models (LLMs), Large Language Model-Retrieval-Augmented Generation (LLM-RAG), etc.

Graphs include nodes and edges that allow for the modeling of various types of data and relationships in AI/ML applications. Clustering algorithms are a fundamental class of unsupervised learning techniques for use in AI/ML applications. Clustering algorithms aim to group a set of objects in such a way that objects in the same group or cluster are more similar to each other than to those in other groups. Clustering is widely used for exploratory data analysis, pattern recognition, and data compression. Principal Component Analysis (PCA) is a widely used dimensionality reduction technique for simplifying complex datasets, reducing noise, and improving the performance of machine learning algorithms. PCA transforms the original features of a dataset into a new set of uncorrelated features called principal components, which capture the most significant variance in the data.

Latent Dirichlet Allocation (LDA) is a generative probabilistic model used in natural language processing and machine learning for topic modeling. In LDA, a topic is a distribution over a fixed vocabulary of word, and each topic represents a specific theme or subject matter, characterized by a set of words that are likely to appear together. Decision trees are a popular and intuitive method used in AI/ML applications for classification and regression tasks. Decision trees are a type of supervised learning algorithm which can handle both categorical and numerical data. Decision trees involve a root node, internal nodes, branches, leaf nodes, splitting, pruning, etc.

Random Forest is an ensemble learning method used in AI/ML for classification, regression, and other tasks by constructing a multitude of decision trees during training and outputting the class that is the mode of the classes or mean prediction of the individual trees. Neural Networks are a fundamental component of deep learning, which is a subset of machine learning. Deep Learning models have shown strong performance in various tasks, such as image recognition, natural language processing, etc. Graph Neural Networks (GNNs) are a class of neural networks designed to operate on graph-structured data. Graphs include nodes and edges, making GNNs suitable for tasks involving relational data. Recurrent Neural Networks (RNNs) are a class of neural networks designed for sequential data, such as time series, text, and speech. Bayesian Models are a class of statistical models that apply Bayes theorem to update the probability of a hypothesis as more evidence or information becomes available.

Community Detection Algorithms are used to identify groups or clusters of nodes in a network that are more densely connected internally than with the rest of the network. These algorithms are essential in various fields, such as social network analysis, biology, and computer science, to uncover the underlying structure and relationships within complex networks. Recommendation Systems, also known as recommender systems, are a subclass of information filtering systems that seek to predict the rating or preference a user would give to an item. These systems are widely used in various applications, such as e-commerce, streaming services, social media, etc.

Large Language Models (LLMs) and Large Language Model-Retrieval-Augmented Generation (LLM-RAG) are advanced AI techniques used in the ORE system 205. LLMs are capable of understanding and generating human-like text based on the data they have been trained on. LLM-RAG combines the strength of LLMs with retrieval mechanisms to enhance the generation of contextuality relevant and accurate information.

In various embodiments, as depicted in FIG. 2B, a user in the organization (e.g., a chief executive officer) can use and trigger the ORE system 205 to find similarities in certain projects and trigger the system 205 to return a result on discovered similarities. In other embodiments, the system 205 is running in the background and can be triggered to perform a certain task. More specifically, tasks can be triggered automatically (e.g. a new code repository being tracked is X % similar to an existing code repository) or triggered by a user (e.g. if a CEO of a particular organization requires cost cutting measures). The data sources 200 are continuously and seamlessly updated with new data 217, as shown with arrows 219. An update could “trigger” the data aggregation agent 202 to re-calculate aggregation parameters (see 218, 219, 220 in FIG. 2B). For instance, triggers of the system 205 and a resulting action are shown in the following table and also illustrated in FIG. 2G.

| Triggers | Actions |
|---|---|
| Need a list of Teams to consolidate | Generates a list of teams to potentially |
| | consolidate |
| CEO requires cost cutting measures | Detect redundancies across the |
| | organization & suggest merges |
| Suggestions for organization re-shuffling | Generates potential teams to create based |
| required | on projects and skillset |
| New project is onboarded | Identifies which team to assign the new |
| | project to |
| Team has a new project or is | Identifies what trainings the team needs |
| underperforming | |
| Teams are detected to work on similar | Compare team performances. |
| projects/apps | Does one team perform significantly |
| | better? |
| | Compare team structures. Are |
| | team structures the same? Is one team |
| | flatter? |
| New code repository being tracked is X % | Suggest reuse of existing code and |
| similar to existing code repository | knowledge transfer |
| Code quality score is low for a project or | Suggest required training |
| team | |
| New project (description, product to | Suggest reuse of existing code and |
| build) has high similarity to existing | knowledge transfer |
| project which is already developed | |
| Other triggers are possible for any type of | |
| event or data that is fed into the system | |

In various embodiments, the selected AI/ML model(s) performs similarity detection (214) and tracking performance metrics for each team (218), as depicted in FIG. 2B. For instance, the selected AI/ML model(s) determine similar teams by finding competing organizations or finding complimentary organizations. Two competing groups are identified by evaluating similarity in applications and organization structure. For instance, metrics must be at least 80%. Two complimentary groups are identified based on skills, team focus, and applications (e.g., two DevOps teams working with the same hardware. In addition, performance metrics for each team can be tracked and analyzed. The selected AI/ML model(s) analyze the determined similar teams and the evaluated performance of each team in order to generate and output recommendation actions. With respect to the actions, feedback from action is gathered to improve the system 205. In various embodiments, the AI/ML model selecting agent 206 is configured to select one or more AI/ML models to perform the similarity detection 214 and tracking of performance metrics.

In various embodiments, a process for the similarity detection 214 and tracking of performance metrics for each team 218 is described. As described in FIG. 2B, the similarity detection 214 is performed to determine similar teams. In order to find similar teams, application descriptions (Data Source 0010) and project outline details (Data Source 0008) in the data source 200 may be used by way of example. A selected AI/ML model is used to summarize descriptions and web scraping to gather external information (e.g., vendor information). For instance, the selected AI/ML model includes a generative AI such as LLM or LLM-RAG. The selected AI/ML model evaluates code repository similarity and project/application technical similarity. User prompt instructs the LLMs to evaluate and score the project or code on different metrics to get an aggregated similarity score. For project, the selected AI/ML model extracts the technical aspect of the application to be built—e.g. Voice AI Assistant, Recommendation Engine. For code, technologies used such as LLM-RAG architecture, churn model etc. are identified. The selected AI/ML model generates summaries and compares and scores how similar the summaries are. Keywords are extracted and compared and scored how similar the keywords are. Numeric scores are generated based on above components. The applications are classified into categories using the selected AI/ML such as LLM on descriptions and features.

An output from the selected AI/ML model include information such as application (“App”) name, App ID, App category, App sub-category, App Features, code technologies, App technologies, code keywords, App keywords, code summary, App summary, App ID 1, App ID 2, Code Score, and App similarity Score.

In various embodiments, similarity in employee capabilities is determined by using the selected AI/ML model. In order to find employee capabilities, employee skills, training and career progression (Data Source 002), access (Data Source 003), system provisioning (Data Source 004), external data sources (e.g., resumes, social network), code and notebooks (Data Source 011) in the data source 200 may be used. A selected AI/ML model such as LLM-RAG and a natural language processing enabled model may be used to extract employee titles, skills, roles, training, and career progression from internal & external data sources. For new employees use external data sources for cold start. Similar skills and titles are consolidated for easy aggregation by creating categories and sub-categories for related roles using word embeddings & clustering (unsupervised) algorithms. Graph traversal and Graph RAGs will be used to aggregate data to a team level, App/Project level, Technology level or Role level, by way of example.

An output from the selected AI/ML models include information such as Name|Title|Aggregated System Access Information (Key Value Pairs (KVPs))|Skills (KVPs)|Expertise (KVPs). KVPs contain key indicating skill or system and value-years of experience with skill or system. The output further includes graphs linking employees in teams. The output also identifies employees with similar profiles across teams.

In various embodiments, similarity in similar team structure is determined by using the selected AI/ML model. In order to find the similar team structure, employee information (Data Source 001), employee skills, training, and career progression (Data Source 002), access (Data Source 003), system provisioning (Data Source 004) and external data sources (e.g., resumes, social network) in the data source 200 may be used. A selected AI/ML model compares the depth and breadth of team structures (graphs created above). Group teams based on employee skills, roles, and project details (from Step B) with Algorithms: Density-Based Spatial Clustering of Applications with Noise (DBSCAN), Collaborative Filtering, Content-Based Filtering, Principal Component Analysis (PCA), t-distributed Stochastic Neighbor Embedding (t-SNE).

An output from the selected AI/ML models include information such as Team A being 80% similar to teams X, Y, Z or Team A is clustered with teams X, Y, Z. Using information from the determining similar employee capabilities described above, categories and sub-categories of past projects/apps are used as input and output is that Team A is complimentary to team X and competing with teams Y and Z.

With respect to tracking performance metrics for each team, interaction patterns such as calendar and other mail services (Data Source 005), system and application access logs (Data Source 006), network flow data (Data Source 007), project and objective data (Data Sources 008˜013), performance ratings data (Data Source 014 and Data Source 002) may be used.

In various embodiments, the selected AI/ML model operates to track performance metrics for each team. The selected AI/ML model may track agility, release frequency, then code size, pull/push requests, financial impact, code quality (time/space complexity, query efficiency), tickets closed, etc. For tickets closed, software tracking program in Data Source 009 is used and the selected AI/ML model is configured to count the number of tickets closed by each employee per week/month and aggregate. An output includes a number of tickets closed per team (aggregated from employee to team level). For frequency of ticket closures, the software tracking program in Data Source 009 is used and the selected AI/ML model is configured to calculate average & total number of tickets closed per week/month by each employee. An output includes frequency of ticket closures per team (aggregated from employee to team level). For pull requests, code and notebooks (Data Source 011), the software tracking program (Data Source 009) in the data source 200 may be used. The selected AI/ML model is configured to count a number of pull requests made by each employee. An output includes a number of pull requests per team (aggregated from employee to team level).

In various embodiments, for resource utilization, system and application access logs (Data Source 006), network flow data (Data Source 007), applications owned (Data Source 010), assigned projects (Data Source 012) in the data source 200 may be used. The selected AI/ML model is configured to analyze system and application logs for usage and application access frequency, monitor network flow data for usage (GB) and access frequency, and track resource assigned per project. An output includes resource utilization metrics per team (aggregated from employee to team level).

For code quality score, code and notebooks (Data Source 011) in the data source 200 may be used. The selected AI/ML model (e.g., LLMs) is configured to evaluate code quality based on factors like readability, maintainability, complexity, and adherence to coding standards. An output includes code quality score per team (normalized by size of team, amount of code and coding categories-UI, backend, database, data science etc.). For code size, code and notebooks (Data Source 011) in the data source 200 may be used. The selected AI/ML (e.g., LLMs) is configured to measure the size of the codebase in lines of code or other relevant metrics. An output includes average & total code size per team.

For predictive financial modeling, financial data (Data Source 013), project outline details (Data Source 008), and assigned projects (Data Source 012) in the data source 200 may be used. The selected AI/ML model is configured to calculate time to completion, budget spending, revenue estimated, and revenue actual. The time to completion uses historical project completion data to predict future completion times. The budget spending tracks current spend and predict future expenditure based on trends. The revenue estimated estimate future revenue based on project outcomes and historical data. The revenue actual compares estimated revenue against actual revenue post-project completion. As a result, predicted time to completion, budget spending, estimated and actual revenue per team are output.

For employee activity, calendar & other Mail Services (Data Source 005), system and application access logs (Data Source 006) in the data source 200 may be used. The selected AI/ML model is configured to count a number of contacts per week at each level, track number of meetings attended, analyze login/logout times, check activity on the network, check physical presence reports or logs from card readers, identify the assigned devices in specific locations such as “office.” An output includes employee activity metrics aggregated to team level.

For past performance, performance ratings (Data Source 014) in the data source 200 may be used. The selected AI/ML model is configured to extract performance ratings on a scale of 1 to 5 for each year and calculate the average performance rating over the employee's tenure. An output includes past performance ratings per team (aggregated from employee to team level). For self-development, training records (Data Source 015) may be used and the selected AI/ML model is configured to track number, hours, complexity, types (hands-on vs lecture) of trainings taken each year per employee, and assess relevance of training to employee's area and adoption of new technologies (by comparing role with skills required to pass the training). The selected AI/ML model is further configured to track presentations/publications at internal and external conferences. An output includes self-development metrics per team. Employee activity metrics are aggregated to a team level.

For ideas submitted, internal suggestion and patent submission systems may be used as a data source (Data Source 0016). The selected AI/ML model is configured to count the number of patents and suggestions submitted by each employee. An output includes a number of ideas submitted per team. Employee data is aggregated to team level. For employee network, calendar & other mail services (Data Source 005) in the data source 200 may be used. The selected AI/ML model is configured to analyze interaction patterns, count number of contacts in network outside of employee organization, and count a number of contacts at each leadership level. An output includes employee network metrics aggregated to team level.

These factors are used to monitor and compare performance metrics across different teams. By way of example, the selected AI/ML model is a LLM and determines a rating of code quality, how many pull/push requests are there, what is the release frequency, what are the code size, using the data stored in the data storage 204. For instance, the LLM can look at the data including Team A having 10 employees, the code quality score 7 out 10, a release of 10,000 lines of code, financial impact of Team A, and the same type data for Team B, and generates an output that Team B is better performing than Team A based on a numeral value generated as a result of the comparison between Team A and Team B with respect to similarities and performance metrics.

Using the determined similarities and the tracked performance metrics described above, optimization suggestions (222) can be generated and output (225) as depicted in FIG. 2B. For instance, the selected AI/ML model includes an LLM and the LLM can retrieve and analyze data about Team A and Team B, for example, Team A having 10 employees, their code quality score being 7 by 10, and Team B having a different number of employees and a different code quality score. Using the LLM, prompts can be provided via a user interface 230, asking about products that are being developed by Team A and Team B, asking to compare a number of members for Team A and Team B and their roles, in order to detect similarities between Team A and Team B. As described above, the data aggregation agent 202 aggregates various aspects of data regarding Team A and Team B which are stored in the data storage 204. The LLM accesses the stored data, can compare Team A and Team B in response to the prompt given and return results such as Team A performs better than Team B. Additionally or alternatively, the system 205 can also use pre-determined pipelines. In that case, the LLM and prompt would be pre-defined and available as part of the pipeline as a tool.

In various embodiments, the AI/ML selection agent 206 includes a memory that can remember past states for a given team. The AI/ML selection agent 206 may have access to the web to pull in other comparative data to supplement data or information.

As further another example, Team A with 8 developers and 2 data scientists performs better than Team B with 5 data scientists and 5 developers because more developers can be used to build and develop end results. As yet another example, each team member's title as well as training that each member has taken so far can be considered, their resumes, skills they have, etc., can be considered. Based on the data aggregated and stored in the data storage 204, quantitative and qualitative aspects of a particular organization can be determined and assessed. As an additional example, Team A and Team B are responsible for deploying certain projects in a communication network and their performance can be tracked such as capital expenditures, installations, analyzing each team, team members, etc. over time, thereby returning results such as Team A performing better than Team B.

In various embodiments, the selected AI/ML model operates to find a problem such as an anomaly or similarities by tracking all code repositories, identifying a new repository that is very similar to one or more repositories that already exist. The selected AI/ML model further operates to determine that a new project on voice assistants is similar to another project that has been done by Team A. Assessing to all code repositories, the selected AI/ML model can identify and leverage all codes or learnings.

As a result, the pool of AI/ML models 210 operate to output recommendations or actions based on optimization analysis (shown as 222) as depicted in FIG. 2B. For instance, the optimization opportunities include Team Structure Optimization, performance-based consolidation, role redundancy reduction, removing overlapping application, consolidating similar code repositories, reducing redundant client meetings, consolidating or reducing related research projects, parallel feature development, duplicate teams, etc. The recommendations or actions are sent to teams, users, HR managers, executive members, etc. via an alert or a notification.

FIG. 2C through 2F depict illustrative examples of optimizations and actions in accordance with various aspects described herein. As depicted in FIG. 2C, the ORE system 205 determines that Team A is 80% similar to Team B and that Team A outperforms Team B. The ORE system 205 generates an action for merging Team B into Team A for better performance and efficiency. Additionally or alternatively, Team B is provided with an automated training plan to improve their performance based on identified gaps. As depicted in FIG. 2D, the ORE system 205 determines that new project details are a good fit for Team C based on specific criteria. The ORE system 205 generates an action that the new project is assigned to Team C. As depicted in FIG. 2E, based on performance metrics, the ORE system 205 determines that Team D is struggling with project X and it is a better fit for Team S based on team structure, skills, and past projects, the ORE system 205 generates an action that shifts Project X to Team S. As depicted in FIG. 2F, the ORE system 205 determines that Code Repository for Project Y is very similar to Project M and both are AI voice assistants, one for mobility and the other for broadband. The ORE system 205 generates an action that leverage learnings, code, and knowledge from Project M which is already developed.

By leveraging aggregated data in the data source 200 to identify these patterns, the ORE system 205 can effectively streamline operations, consolidate efforts, and deduplicate resources, leading to enhanced organizational efficiency and synergy, utilizing the AI/ML model 210. The ORE system 205 generates recommendations as an output where the recommendations include various actions 220 such as role redundancy reduction, performance based consolidation, structure optimization (flattening teams), merging silos, deploying training or improvement plans, etc. Additionally, as described above, FIG. 2G depicts further illustrative examples of various triggers and resulting actions in accordance with various aspects described herein.

FIG. 2H depicts an illustrative embodiment of a method 230 in accordance with various aspects described herein. In various embodiments, the method 230 includes collecting, using a set of analytics tools, internal datasets such that the internal datasets represent a comprehensive map of activities by a plurality of operation teams in a target organization, wherein the internal datasets include different data sources and each data source corresponds to a plurality of key data points representing characteristics of the plurality of operation teams in the target organization (Step 232). as depicted as the data source 200 in FIG. 2A. The collected and aggregated data can be classified and labeled with specific codes or predetermined identifications. Data are continuously collected and the system is refined to adapt to evolving organizational needs. The method 230 further includes generating, using a data aggregation agent, aggregated data of the internal datasets (Step 234).

In various embodiments, the method 230 further includes, based on an automatic trigger or a trigger by a user, performing an optimization process (Step 235). The performing of the optimization process (Step 235) includes, in a pool of artificial intelligence/machine learning (AI/ML) models, selecting, using an AI/ML selection agent, a set of AI/ML models to identify similarities in the characteristics of the plurality of operation teams (Step 236). The identifying similarities are directed to detecting similarity, duplication, redundancy, separation, hierarchy, etc. in employee utilization, product management, project management, resource allocation, resource utilization, etc. By way of example only, the identifying similarity includes products where Team A and Team B are building or handling. As another example, the identifying similarities include structural similarity in Team C and Team D, such as 20 developers, 2 project managers, 10 QA engineers.

In various embodiments, in the method 230, the performing of the optimization process (Step 235) further includes, using the aggregated data, analyzing performance metrics of the plurality of operation teams (Step 238). As one example, each structure of Team A and Team B is compared and analyzed (e.g., a number of employees, their roles, products in progress). As another example, employee utilization in Team C and Team D is analyzed using various tools such as calendar, system and application logs, network monitoring tools, network flow data, ticket data, etc. As a result of the analysis, a determination that QA engineers are underutilized in both teams can be made. As further another example, performance metrics of Team A and Team B are compared which may lead to a determination that Team A outperforms Team B. Comparing the performance metrics of Team A and Team B can be done using employee skill tools, training and career progression database, etc.

The method 230 further includes, based on the identified similarities and the analyzed performance metrics, generate an output including optimization actions of the plurality of operation teams (Step 240). Recommended changes are implemented and their impact on organizational efficiency is monitored. For instance, using the examples above, the optimization recommendations include merging Team A and Team B with an automated training plan for improvement, merging Team C and Team D and reducing a number of QA engineers to a certain count, modifying the structure of Team A or Team B to reduce redundant roles, etc.

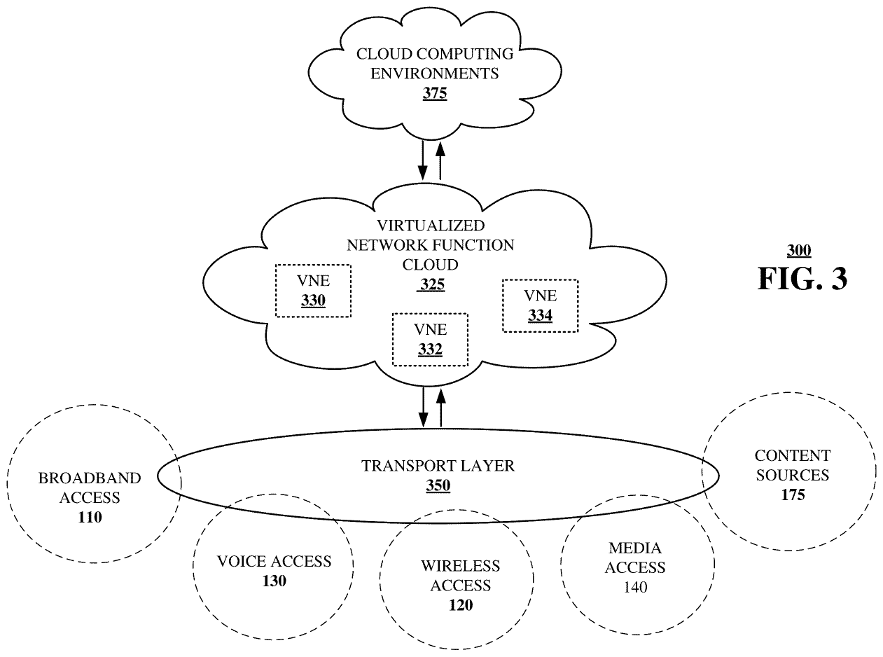

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part artificial intelligence/machine learning (AI/ML) driven organization recommendation engine systems and methods.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

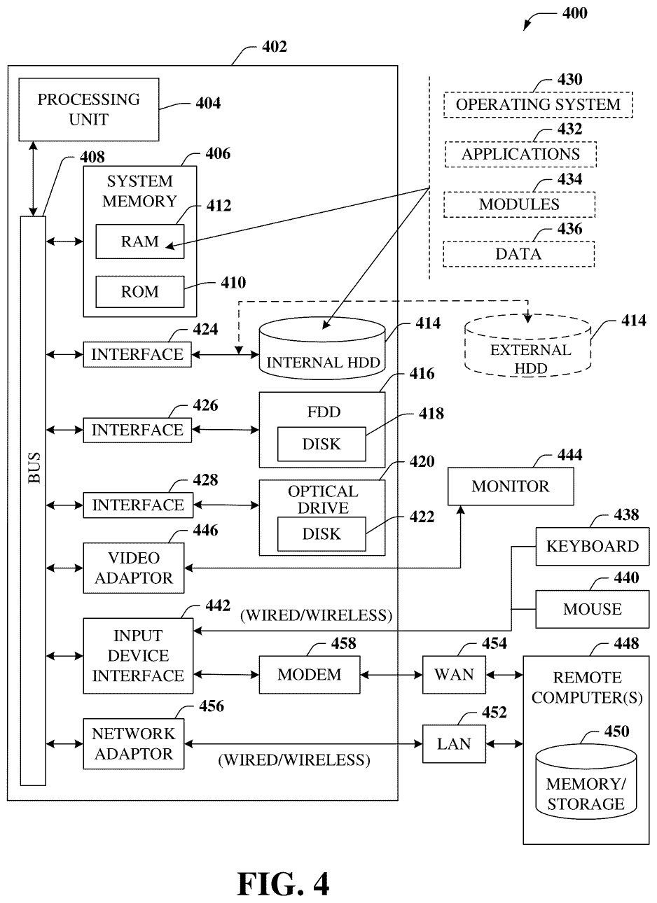

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part artificial intelligence/machine learning (AI/ML) driven organization recommendation engine systems and methods.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

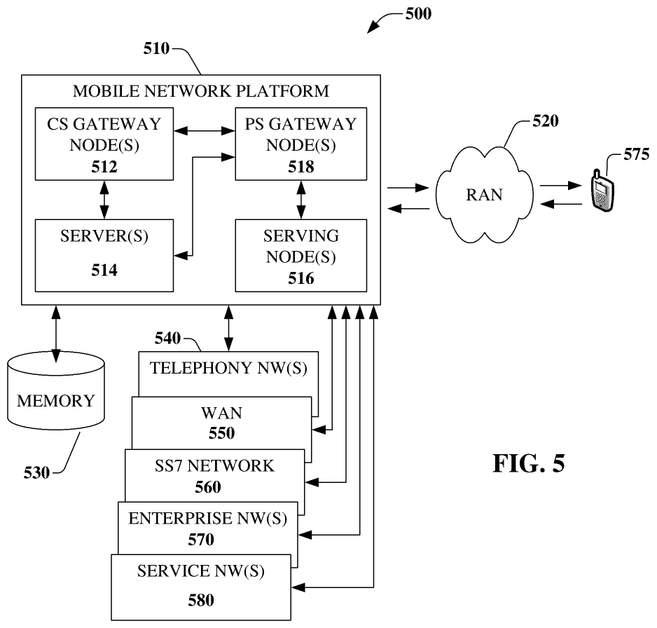

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part artificial intelligence/machine learning (AI/ML) driven organization recommendation engine systems and methods. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

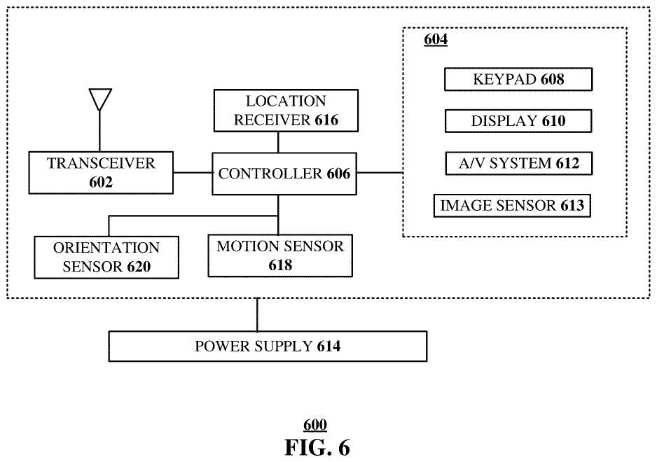

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part artificial intelligence/machine learning (AI/ML) driven organization recommendation engine systems and methods.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A non-transitory machine-readable medium, comprising executable instructions that, when executed by a processing system including a processor, facilitate performance of operations, the operations comprising:
collecting, using a set of analytics tools, internal datasets such that the internal datasets represent a comprehensive map of activities by a plurality of operation teams in a target organization, wherein the internal datasets include different data sources and each data source corresponds to a plurality of key data points representing characteristics of the plurality of operation teams in the target organization;
generating, using a data aggregation agent, aggregated data of the internal datasets;
based on an automatic trigger or a trigger by a user, performing an optimization process including:
in a pool of artificial intelligence/machine learning (AI/ML) models, selecting, using an AI/ML selection agent, a set of AI/ML models to identify similarities in the characteristics of the plurality of operation teams; and
using the aggregated data, analyzing performance metrics of the plurality of operation teams; and
based on the identified similarities and the analyzed performance metrics, generating an output including optimization actions of the plurality of operation teams.

2. The non-transitory machine-readable medium of claim 1, wherein selecting the set of AI/ML models further comprises selecting a large language model (LLM); and
wherein the operations further comprise:
receiving, via a user interface, prompts; and
providing, to the LLM, the prompts instructing the LLM to retrieve information about a first team and a second team using the aggregated data, compare the first team and the second team, and return a result of the comparison that designates a better performing team between the first team and the second team within the plurality of operation teams.

3. The non-transitory machine-readable medium of claim 1, wherein the operations further comprise automatically triggering an optimization process, wherein the optimization process includes the identifying similarities and the analyzing performance metrics of the plurality of operation teams, and
wherein the identifying similarities further comprises:
identifying two or more similar teams among the plurality of operations teams by determining applications similarity, employee capability similarity, and team structure similarity with respect to the plurality of operation teams, wherein applications include technical projects handled across the plurality of operation teams, and team structure correspond to a different composition of employee capability within each of the plurality of operation teams.

4. The non-transitory machine-readable medium of claim 3, wherein the determining applications similarity further comprises:
based on the aggregated data and web scraping, using the set of AI/ML models including Language Model-Retrieval-Augmented Generation (LLM-RAG), comparing descriptions of the applications, vendor information, codes used for the applications from code repositories, code keywords, and application keywords; and
outputting application (“App”) name, App ID, App category, App sub-category, App Features, code technologies, App technologies, code keywords, App keywords, code summary, App summary, App ID 1, App ID 2, Code Score, App similarity Score or a combination thereof.

5. The non-transitory machine-readable medium of claim 4, wherein the determining employee capability similarity further comprises:
based on the aggregated data, using the set of AI/ML models including clustering algorithms, Graph traversal and Graph RAGs, extracting and classifying employee titles, skills, roles, training, and career progression; and
outputting identification of employees with comparable profiles across the plurality of operation teams.

6. The non-transitory machine-readable medium of claim 5, wherein the determining team structure similarity comprises:
based on the aggregated data, using the set of AI/ML models including K-means, Hierarchical Clustering, Density-Based Spatial Clustering of Applications with Noise (DBSCAN), Collaborative Filtering, Content-Based Filtering, Principal Component Analysis (PCA), t-distributed Stochastic Neighbor Embedding (t-SNE) or a combination thereof, grouping the plurality of operation teams based on the extracted and classified employee titles, skills, roles, training, and career progression; and
outputting identification of a first team that is complimentary to a second team and competing with a third team among the plurality of operation teams.

7. The non-transitory machine-readable medium of claim 1, wherein the operations comprise:
using a first set of analytics tools, collecting data directed to applications, team structures, and employee capabilities that belong to the plurality of operation teams; and
using a second set of analytics tools, tracking, by the processing system, the performance metrics indicative of performance levels by the plurality of operation teams.

8. The non-transitory machine-readable medium of claim 7, wherein the tracking the performance metrics comprises tracking a number of tickets closed, a frequency of ticket closures, a number of pull requests, resource utilization, a code quality score, a code size, predictive financial modeling, employee activity, past performance, self-development, ideas submitted, employee network or a combination thereof.

9. A method, comprising:
collecting, by a processing system including a processor, internal datasets such that the internal datasets represent a comprehensive map of activities by a plurality of operation teams in a target organization,
wherein the internal datasets contain different data sources and each data source includes a plurality of key data points representing characteristics of the plurality of operation teams in the target organization;
generating, by the processing system, aggregated data of the internal datasets;
triggering an optimization process including:
in a pool of artificial intelligence/machine learning (AI/ML) models, selecting a set of AI/ML models trained to identify similarity within the plurality of operation teams; and
analyzing performance metrics indicative of performance levels by the plurality of operation teams, wherein the performance metrics are included in the internal datasets; and
based on the identified similarity and the analyzed performance metrics, generating an output including optimization actions directed to the plurality of operation teams in the target organization.

10. The method of claim 9, wherein the collecting further comprises:
using a first set of analytics tools, collecting data directed to applications, team structures, and employee capabilities that belong to the plurality of operation teams; and
using a second set of analytics tools, tracking, by the processing system, the performance metrics indicative of performance levels by the plurality of operation teams.

11. The method of claim 10, wherein the tracking the performance metrics comprises tracking a number of tickets closed, a frequency of ticket closures, a number of pull requests, resource utilization, a code quality score, a code size, predictive financial modeling, employee activity, past performance, self-development, ideas submitted, employee network or a combination thereof.

12. The method of claim 9, wherein the selecting the set of AI/ML models further comprises selecting a generative AI model; and
wherein the method further comprises providing, to the generative AI model, a prompt instructing to retrieve information about a first team and a second team from the aggregated data, compare the first team and the second team, and returns a result of the comparison that designates a better performing team between the first team and the second team.

13. The method of claim 9, wherein the triggering of the optimization process further comprises triggering the optimization process based on a user initiated trigger.

14. A system, comprising:
a processing system including a processor; and
a memory that stores executable instructions that, when executed by the processing system, facilitate performance of operations, the operations comprising:
collecting internal datasets such that the internal datasets represent a comprehensive map of activities by a plurality of operation teams in a target organization,
wherein the internal datasets contain different data sources and each data source includes a plurality of key data points representing characteristics of the plurality of operation teams in the target organization;
generating, by the processing system, aggregated data based on the different data sources of the internal datasets;
based on a trigger by the system or by a user, performing an optimization process including:
in a pool of artificial intelligence/machine learning (AI/ML) models, selecting a set of AI/ML models trained to identify predetermined patterns across the plurality of operation teams; and
based on the aggregated data, analyzing performance metrics of the plurality of operation teams; and
using the identified predetermined patterns and the analyzed performance metrics, generating actions that optimize the plurality of operation teams in the target organization.

15. The system of claim 14, wherein the collecting further comprises:
using a first set of analytics tools, collecting data directed to applications, team structures, and employee capabilities that belong to the plurality of operation teams; and
using a second set of analytics tools, tracking, by the processing system, the performance metrics indicative of performance levels by the plurality of operation teams.

16. The system of claim 15, wherein the tracking the performance metrics comprises tracking a number of tickets closed, a frequency of ticket closures, a number of pull requests, resource utilization, a code quality score, a code size, predictive financial modeling, employee activity, past performance, self-development, ideas submitted, employee network or a combination thereof.

17. The system of claim 14, wherein the operations further comprise:
executing a first agent configured to aggregate the different data sources of the internal datasets and the performance metrics; and
executing a second agent configured to select the set of AI/ML models in the pool of AI/ML models.

18. The system of claim 14, wherein the identifying the predetermined patterns across the plurality of operation teams further comprises identifying similarity in applications handled by the plurality of operation teams by:
based on the aggregated data containing application descriptions and project outline details, comparing descriptions of the applications, vendor information, codes used for the applications from code repositories, code keywords, and application keywords; and
outputting application (“App”) name, App ID, App category, App sub-category, App Features, code technologies, App technologies, code keywords, App keywords, code summary, App summary, App ID 1, App ID 2, Code Score, App similarity Score or a combination thereof, wherein the set of AI/ML models includes Language Model-Retrieval-Augmented Generation (LLM-RAG).

19. The system of claim 14, wherein the identifying the predetermined patterns across the plurality of operation teams further comprises identifying similarity in employee capabilities across the plurality of operation teams by:
based on the aggregated data containing employee skills, training, career progression, access, system provisioning, and code and notebooks, extracting and classifying employee titles, skills, roles, training, and career progression; and
outputting identification of employees with comparable profiles across the plurality of operation teams, wherein the set of AI/ML models includes clustering algorithms, Graph traversal and Graph RAGs.

20. The system of claim 19, wherein the identifying the predetermined patterns across the plurality of operation teams further comprises identifying similarity in team structure across the plurality of operation teams by:
based on the aggregated data including employee information, employee skills, training, and career progression, the access, and the system provisioning, grouping the plurality of operation teams based on the extracted and classified employee titles, skills, roles, training, and career progression; and
outputting identification of a first team that is complimentary to a second team and competing with a third team among the plurality of operation teams, wherein the set of AI/ML models includes K-means, Hierarchical Clustering, Density-Based Spatial Clustering of Applications with Noise (DBSCAN), Collaborative Filtering, Content-Based Filtering, Principal Component Analysis (PCA), t-distributed Stochastic Neighbor Embedding (t-SNE) or a combination thereof.
